(19) United States
(12) Patent Application Publication
(10) Pub. No.: US 2025/0024561 A1
(43) Pub. Date: Jan. 16, 2025

(54) CERAMIC HEATER

(71) Applicant: NGK INSULATORS, LTD., Nagoya-City (JP)

(72) Inventor: Shingo AMANO, Chita-Gun (JP)

(73) Assignee: NGK INSULATORS, LTD., Nagoya-City (JP)

(21) Appl. No.: 18/636,352

(22) Filed: Apr. 16, 2024

Related U.S. Application Data
(63) Continuation of application No. PCT/JP2023/025885, filed on Jul. 13, 2023.

(51) Int. Cl. H05B 3/14; H05B 3/00; H05B 3/08; H05B 3/56

(52) U.S. Cl. CPC H05B 3/143; H05B 3/0019; H05B 3/08; H05B 3/56

(57) ABSTRACT

A ceramic heater includes: a ceramic plate having a wafer placement surface on its upper surface; a plurality of zones in the wafer placement surface; a zone heater embedded in the ceramic plate for each of the plurality of zones; a single temperature detector passage in the ceramic plate; and a single temperature detector (multi TC) in the temperature detector passage. The temperature detector passage extends from the inlet in a lower surface of the ceramic plate through each of the plurality of zones. The multi TC has a plurality of temperature detecting portions. The temperature detecting portions are positioned at measurement positions corresponding to the plurality of zones.

### BACKGROUND OF THE INVENTION

### 1. Field of the Invention

The present invention relates to a ceramic heater.

### 2. Description of the Related Art

Semiconductor manufacturing apparatuses include ceramic heaters to heat wafers. As such a ceramic heater, a so-called multi-zone heater is known. As disclosed in PTL 1, a multi-zone heater of this type includes heating elements capable of partly heating corresponding zones of a ceramic plate and temperature sensors located near the corresponding heating elements. The temperature sensors send temperature feedback information to an external controller. The controller controls the power to be applied to the heating elements of the zones based on the temperature feedback information.

### CITATION LIST

### Patent Literature

PTL 1: JP 2023-055790 A

### SUMMARY OF THE INVENTION

However, the multi-zone heater of PTL 1 requires multiple holes in the ceramic plate through which the wires of the temperature sensors pass.

The present invention was made to solve the problem, and the main object thereof is to simplify the configuration of the ceramic plate of the ceramic heater in which the temperatures of the zones can be measured.

[1] A ceramic heater according to the present invention includes: a ceramic plate having a wafer placement surface on its upper surface; a plurality of zones in the wafer placement surface; a zone heater embedded in the ceramic plate for each of the plurality of zones; a single temperature detector passage in the ceramic plate; and a single temperature detector located in the temperature detector passage. The temperature detector passage extends from an inlet in a lower surface of the ceramic plate through each of the plurality of zones, and the temperature detector has a plurality of temperature detecting portions, and the plurality of temperature detecting portions are positioned at measurement positions corresponding to the plurality of zones.

In the ceramic heater according to the present invention, the temperature detector passage extends from the inlet in the lower surface of the ceramic plate through each of the plurality of zones. Furthermore, the single temperature detector has the plurality of temperature detecting portions, and the temperature detecting portions are positioned at the measurement positions corresponding to the plurality of zones. This configuration eliminates the need for holes for a large number of temperature sensors in the ceramic plate 20, which were required in the conventional ceramic plate, simplifying the configuration of the ceramic plate 20.

[2] The ceramic heater according to the present invention (the ceramic heater according to the above [1]) may further include: a hollow shaft on the lower surface of the ceramic plate; and a shaft inner area that is an area of the lower surface of the ceramic plate bounded by the hollow shaft, wherein the inlet of the temperature detector passage may be in the shaft inner area. In the ceramic heater including the hollow shaft, although various components (such as power feeders for the zone heaters) are disposed in a relatively narrow shaft inner area on the lower surface of the ceramic plate, the shaft inner area does not need to have holes for a large number of temperature sensors, enabling effective use of the shaft inner area.

[3] In the ceramic heater according to the present invention (the ceramic heater according to the above [1] or [2]), the temperature detector passage may be curved. This configuration that has the curved temperature detector passage enables the temperature detector to be smoothly inserted into the temperature detector passage.

[4] In the ceramic heater according to the present invention (the ceramic heater according to any one of the above [1] to [3]), the plurality of zones may include a circular center zone having a diameter smaller than that of the ceramic plate and a plurality of divided outer zones that are divided zones of a ring-shaped outermost outer zone having an outer diameter equal to the diameter of the ceramic plate and an inner diameter equal to or larger than the diameter of the center zone, wherein the temperature detector passage may have a swirl shape extending from the inlet through the measurement position corresponding to the center zone and then sequentially through the measurement positions for the plurality of divided outer zones. This configuration that has the temperature detector passage having a swirl shape, not a meandering shape, enables the temperature detector passage to have a relatively short length.

[5] In the ceramic heater according to the present invention (the ceramic heater according to any one of the above [1] to [4]), the temperature detector may include a single flexible protective tube housing a plurality of thermocouples having different lengths, the plurality of thermocouples may have the temperature detecting portions at their front ends, and wiring lines connected to the plurality of thermocouples may be bundled into a wiring assembly at a bottom end of the temperature detector. This configuration enables easy connection of the temperature detecting portions of the temperature detector to an external device via the wiring assembly.

[6] In the ceramic heater according to the present invention (the ceramic heater according to any one of the above [1] to [5]), the temperature detector passage may have a width of 1.5 mm to 3.0 mm and a height of 1.5 mm to 3.0 mm.

### BRIEF DESCRIPTION OF THE DRAWINGS

FIG. 1 is a perspective view of a ceramic heater 10. FIG. 2 is a cross-sectional view taken along A-A in FIG. 1.

FIG. 3 is a top cross-sectional view of a ceramic plate 20 taken horizontally along a center zone heater formation plane.

FIG. 4 is a top cross-sectional view of the ceramic plate 20 taken horizontally along a temperature detector passage 30.

FIG. 5 is a front view of a multi TC 40. FIG. 6 is a cross-sectional view taken along B-B in FIG. 5.

FIG. 7 is a block diagram indicating connection between a controller 80 and a ceramic heater 10.

### DETAILED DESCRIPTION OF THE INVENTION

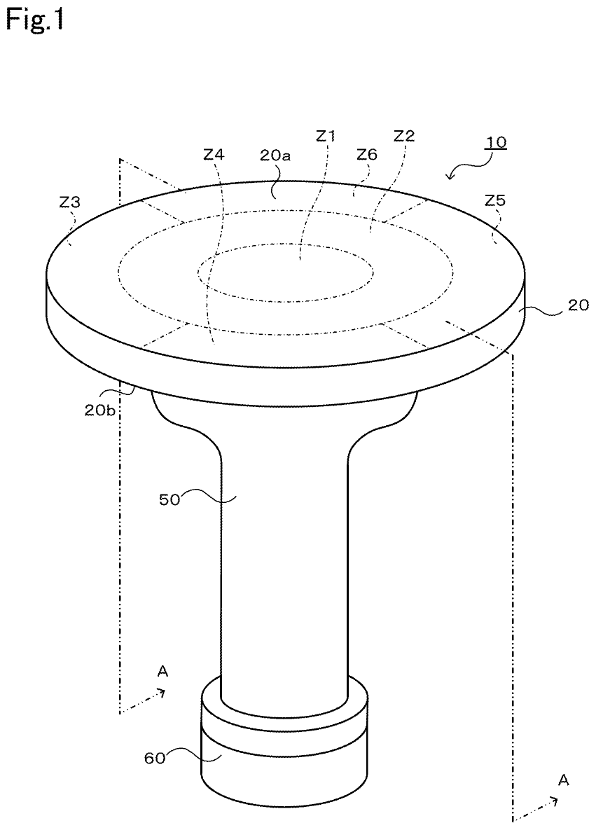

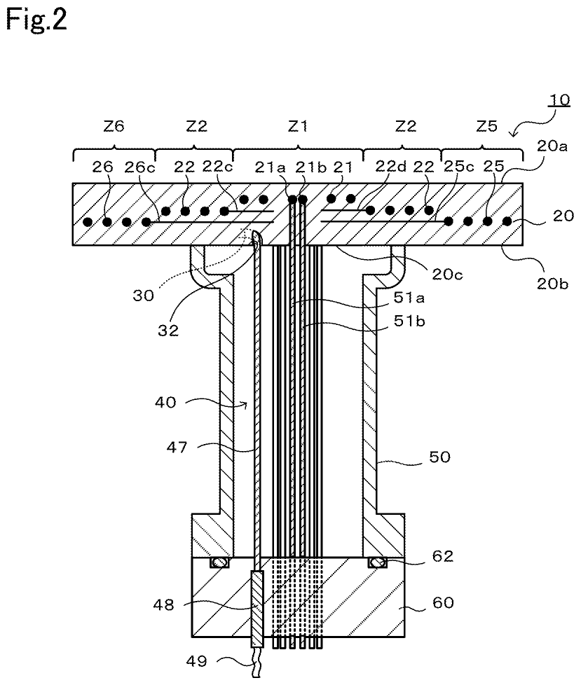

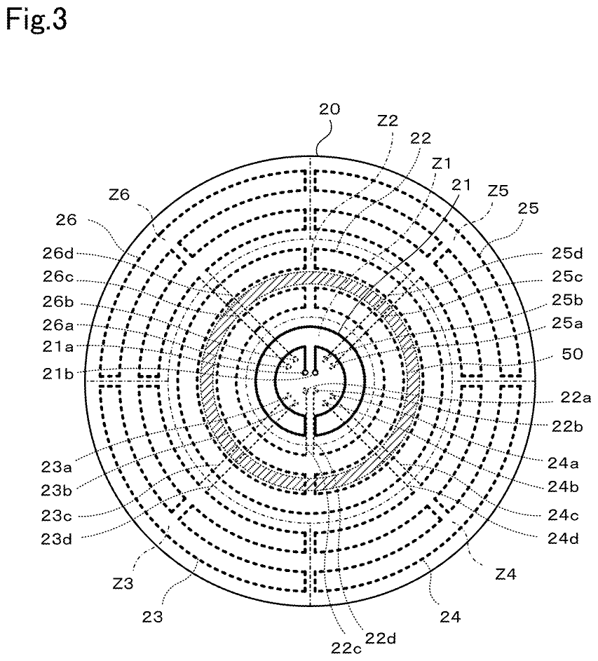

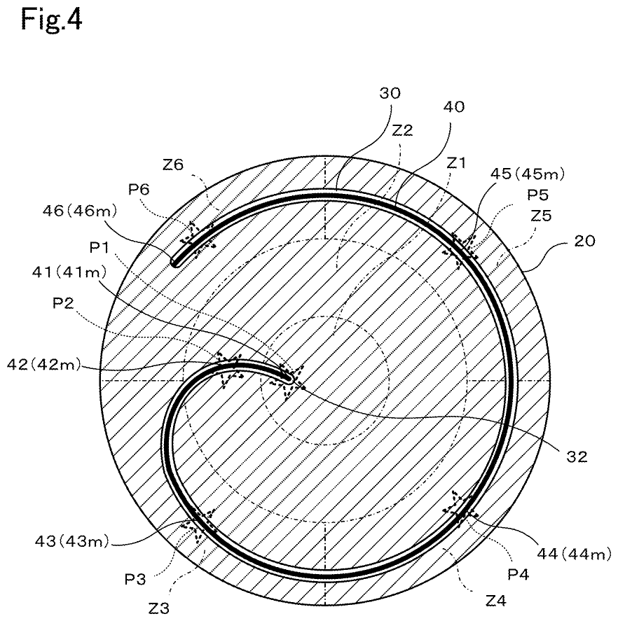

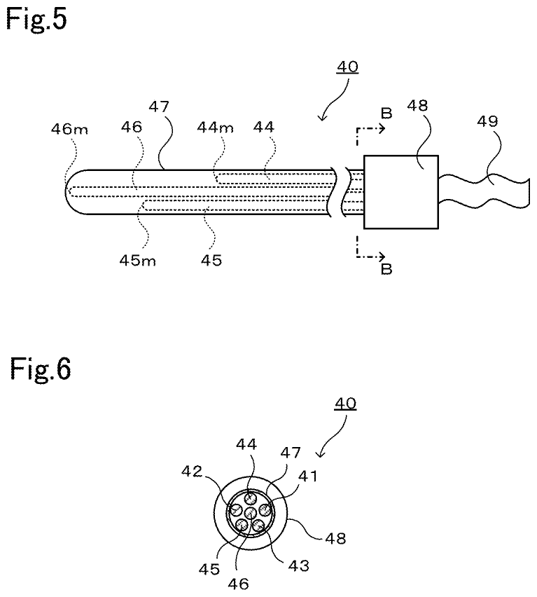

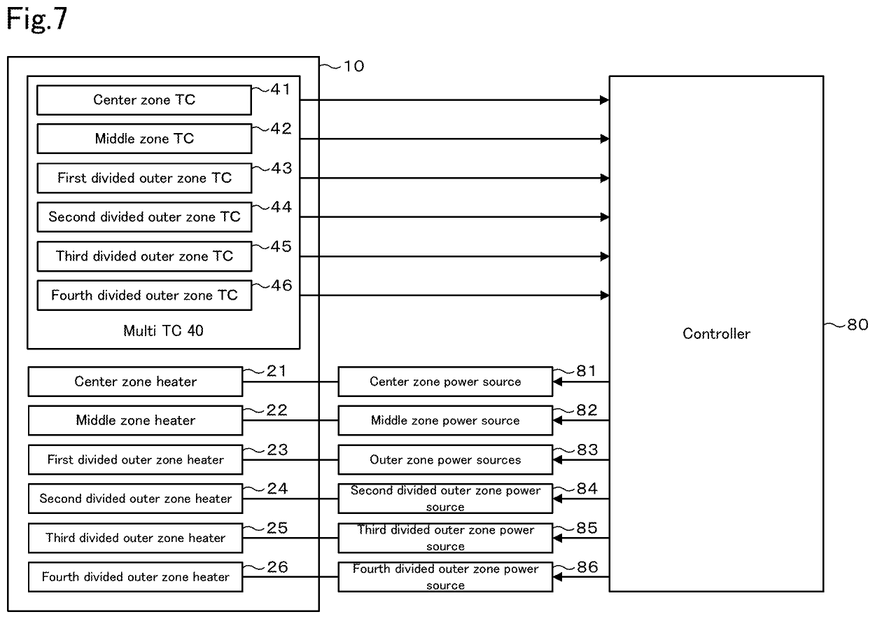

A preferred embodiment of the present invention will be described below with reference to the drawings. FIG. 1 is a perspective view of a ceramic heater 10. FIG. 2 is a cross-sectional view taken along A-A in FIG. 1. FIG. 3 is a top cross-sectional view of a ceramic plate 20 taken horizontally along a center zone heater formation plane. FIG. 4 is a top cross-sectional view of the ceramic plate 20 taken horizontally along a temperature detector passage 30. FIG. 5 is a front view of a multi TC 40. FIG. 6 is a cross-sectional view taken along B-B in FIG. 5. FIG. 7 is a block diagram indicating connection between a controller 80 and a ceramic heater 10. In FIG. 2, jumpers 22c, 22d, 25c, and 26c are indicated by solid lines for convenience of explanation. In FIG. 3, for convenience of explanation, the cross-sectional surface is not hatched, and the cross section of the tubular shaft 50 is illustrated.

The ceramic heater 10, which is used to heat wafers to be subjected to a process such as etching or CVD, is placed in a vacuum chamber (not illustrated). The ceramic heater 10 has a disc-shaped ceramic plate 20 having a wafer placement surface 20a on its upper surface and a hollow tubular shaft 50 joined to a surface (lower surface) 20b of the ceramic plate 20 opposite from the wafer placement surface 20a.

The ceramic plate 20 is a disc-shaped plate formed of a ceramic, such as aluminum nitride and alumina. The wafer placement surface 20a of the ceramic plate 20 has a circular center zone Z1, a ring-shaped middle zone Z2, and a ring-shaped outermost outer zone, which are defined by two virtual different-diameter circles concentric with the ceramic plate 20. The outer zone has four fan-shaped zones (first to fourth divided outer zones Z3 to Z6) divided by four line segments extending in the radial direction of the ceramic plate 20.

In the ceramic plate 20, a zone heater is embedded for each of the plurality of zones Z1 to Z6. Specifically, as illustrated in FIG. 3, in the ceramic plate 20, a center zone heater 21 corresponding to the center zone 21 is embedded, a middle zone heater 22 corresponding to the middle zone 22 is embedded, a first divided outer zone heater 23 corresponding to the first divided outer zone Z3 is embedded, a second divided outer zone heater 24 corresponding to the second divided outer zone 24 is embedded, a third divided outer zone heater 25 corresponding to the third divided outer zone 25 is embedded, and a fourth divided outer zone heater 26 corresponding to the fourth divided outer zone Z6 is embedded. These heaters 21 to 26 are each composed of a resistance heating element that generates heat when electric current passes through it. Examples of the resistance heating element include coils, printed electrodes, and ribbons formed mainly of molybdenum, tungsten, or tungsten carbide.

The center zone heater 21 is on the center zone heater formation plane (plane parallel to the wafer placement surface 20a) located inside the ceramic plate 20. The center zone heater 21 extends in a one-stroke pattern from a terminal 21a near the center of the ceramic plate 20 over almost the entire area of the center zone Z1 to a terminal 21b.

The middle zone heater 22 is on a middle zone heater formation plane (plane parallel to the wafer placement surface 20a) that is different from the center zone heater formation plane. The middle zone heater 22 extends in a one-stroke pattern over almost the entire area of the middle zone Z2. The ends of the middle zone heater 22 are connected to jumpers 22c and 22d on the middle zone heater formation plane. The jumpers 22c and 22d are connected to terminals 22a and 22b near the center of the ceramic plate 20.

The first to fourth divided outer zone heaters 23 to 26 are on an outer zone heater formation plane (plane parallel to the wafer placement surface 20a) that is different from the center zone heater formation plane and the middle zone heater formation plane. The first divided outer zone heater 23 extends in a one-stroke pattern over almost the entire area of the first divided outer zone Z3. The ends of the first divided outer zone heater 23 are connected to jumpers 23c and 23d on the outer zone heater formation plane. The jumpers 23c and 23d are connected to terminals 23a and 23b near the center of the ceramic plate 20.

The second divided outer zone heater 24 extends in a one-stroke pattern over almost the entire area of the second divided outer zone Z4. The ends of the second divided outer zone heater 24 are connected to jumpers 24c and 24d on the outer zone heater formation plane. The jumpers 24c and 24d are connected to terminals 24a and 24b near the center of the ceramic plate 20.

The third divided outer zone heater 25 extends in a one-stroke pattern over almost the entire area of the third divided outer zone Z5. The ends of the third divided outer zone heater 25 are connected to jumpers 25c and 25d on the outer zone heater formation plane. The jumpers 25c and 25d are connected to terminals 25a and 25b near the center of the ceramic plate 20.

The fourth divided outer zone heater 26 extends in a one-stroke pattern over almost the entire area of the fourth divided outer zone Z6. The ends of the fourth divided outer zone heater 26 are connected to jumpers 26c and 26d on the outer zone heater formation plane. The jumpers 26c and 26d are connected to terminals 26a and 26b near the center of the ceramic plate 20.

As illustrated in FIG. 4, the ceramic plate 20 internally has a single temperature detector passage 30 on a plane parallel to the wafer placement surface 20a (e.g., plane below the heater formation planes). The temperature detector passage 30 extends from an inlet 32, which extends vertically from a shaft inner area 20c of the lower surface 20b of the ceramic plate 20 bounded by the tubular shaft 50 (see FIG. 2), through each of the plurality of zones Z1 to Z6. The inlet 32 extends vertically and then curves to extend horizontally. Specifically, the temperature detector passage 30 extends through, in this order from the inlet 32, the center zone Z1, the middle zone Z2, the first divided outer zone Z3, the second divided outer zone Z4, the third divided outer zone 25, and the fourth divided outer zone Z6. The temperature detector passage 30 has a width of, for example, 1.5 to 3.0 mm in a direction parallel to the wafer placement surface 20a. The temperature detector passage 30 has a height of, for example, 1.5 to 3.0 mm in a direction perpendicular to the wafer placement surface 20a. The temperature detector passage 30 has a swirl shape (a kind of curvilinear shape) extending in the horizontal direction. The temperature detector passage 30 has measurement positions P1 to P6 corresponding to the plurality of zones Z1 to Z6. In FIG. 4, dotted starts indicate the measurement positions P1 to P6.

A multi TC 40, which is a single temperature detector, is placed in the temperature detector passage 30. TC represents thermocouple. The multi TC 40 has a plurality of temperature detecting portions 41m to 46m. As illustrated in FIGS. 5 and 6, the multi TC 40 includes a single flexible protective tube 47 housing a plurality of sheathed TCs 41 to 46 having different lengths. The protective tube 47 is formed of, for example, a metal (such as SUS 316), and the protective tube 47 has a thickness of, for example, 0.1 to 0.3 mm and a diameter of, for example, about 1.0 mm. The sheaths of the sheathed TCs 41 to 46 are formed of, for example, a metal (such as SUS 316) and have a thickness of, for example, 0.1 to 0.3 mm. The inside of the sheath is filled with an insulating material (e.g., MgO), and the TC is buried in the insulating material. The inside of the protective tube 47 is not filled with an insulating material. The temperature detecting portions 41m to 46m are the front ends of the sheathed TCs 41 to 46 (the front ends of the TCs inside the sheathed TCs 41 to 46). The bottom ends of the sheathed TCs 41 to 46 are fixed to a sleeve 48 located at the bottom end of the protective tube 47. Wires connected to the corresponding sheathed TCs 41 to 46 are bundled into a flat cable 49, which is a wiring assembly attached to the sleeve 48. As illustrated in FIG. 2, the sleeve 48 is mounted on a support 60 attached to the lower end of the tubular shaft 50.

The multi TC 40 is configured in such a manner that, when the tip of the protective tube 47 inserted into the temperature detector passage 30 through the inlet 32 in the ceramic plate 20 reaches the end of the temperature detector passage 30, the temperature detecting portions 41m to 46m of the six sheathed TCs 41 to 46 in the protective tube 47 of the multi TC 40 are positioned at predetermined corresponding measurement positions. Specifically, the temperature detecting portion 41m of the sheathed TC 41 is positioned at the measurement position P1 corresponding to the center zone Z1. The temperature detecting portion 42m of the sheathed TC 42 is positioned at the measurement position P2 corresponding to the middle zone Z2. The temperature detecting portion 43m of the sheathed TC 43 is positioned at the measurement position P3 corresponding to the first divided outer zone Z3. The temperature detecting portion 44m of the sheathed TC 44 is positioned at the measurement position P4 corresponding to the second divided outer zone Z4. The temperature detecting portion 45m of the sheathed TC 45 is positioned at the measurement position P5 corresponding to the third divided outer zone Z5. The temperature detecting portion 46m of the sheathed TC 46 is positioned at the measurement position P6 corresponding to the fourth divided zone Z6.

The tubular shaft 50 is formed of a ceramic, such as aluminum nitride and alumina, like the ceramic plate 20. As illustrated in FIG. 2, the tubular shaft 50 is joined to the ceramic plate 20 at the top end and connected hermetically to the support 60 at the bottom end by using an O-ring 62. The tubular shaft 50 houses feeder rods 51a and 51b connected to the corresponding terminals 21a and 21b of the center zone heater 21, feeder rods connected to the corresponding terminals 22a and 22b of the middle zone heater 22, feeder rods connected to the corresponding terminals 23a and 23b of the first divided outer zone heater 23, feeder rods connected to the corresponding terminals 24a and 24b of the second divided outer zone heater 24, feeder rods connected to the corresponding terminals 25a and 25b of the third divided outer zone heater 25, and feeder rods connected to the corresponding terminals 26a and 26b of the fourth divided outer zone heater 26. These feeder rods extend vertically through the support 60. The tubular shaft 50 also houses the multi TC 40. The sleeve 48 of the multi TC 40 is supported on the support 60. The protective tube 47 and the sheathed TCs 41 to 46 in the protective tube 47 extend vertically in the tubular shaft 50 and extend horizontally in the temperature detector passage 30.

As illustrated in FIG. 7, the controller 80 is configured as a microprocessor having a CPU as a main component and includes a memory for storing various processing programs and various data. The controller 80 is connected to the flat cable 49 of the multi TC 40 (i.e., signal lines of the sheathed TCs 41 to 46) to receive temperature signals from them. The controller 80 is connected to a center zone power source 81 connected to the center zone heater 21, a middle zone power source 82 connected to the middle zone heater 22, and first to fourth divided outer zone power sources 83 to 86 connected to the first to fourth divided outer zone heaters 23 to 26 to send control signals to them. The controller 80 performs feed back control in which the controller 80 receives temperature signals from the sheathed TCs 41 to 46 and sends control signals to the power sources 81 to 86, so that each of the zones Z1 to Z6 has the preset target temperature.

Next, a usage example of the ceramic heater 10 will be described. First, the ceramic heater 10 is disposed in a vacuum chamber (not illustrated), and then a wafer is placed on the wafer placement surface 20a of the ceramic heater 10. Then, the zone power sources 81 to 86 are controlled so that the temperatures detected by the sheathed TCs 41 to 46 become the predetermined target temperatures of the zones. In this way, the temperature of the wafer is controlled to achieve a desired temperature. Then, the vacuum chamber is set to create a vacuum or reduced-pressure atmosphere, and plasma is generated in the vacuum chamber. The wafer is subjected to CVD deposition or etching using the plasma.

In the ceramic heater 10 of the above-described embodiment, the temperature detector passage 30 extends from the inlet 32 in the lower surface of the ceramic plate 20 through each of the plurality of zones Z1 to Z6. Furthermore, the multi TC 40, which is a single temperature detector, has the temperature detecting portions 41m to 46m, and the temperature detecting portions 41m to 46m are positioned at the measurement positions P1 to P6 corresponding to the plurality of zones Z1 to Z6. This configuration eliminates the need for holes for a large number of temperature sensors in the ceramic plate 20, which were required in the conventional ceramic plate, simplifying the configuration of the ceramic plate 20.

Furthermore, in the ceramic heater 10 including the hollow tubular shaft 50, although various components (such as power feeders for the zone heaters 21 to 26 and the multi TC 40) are disposed in a relatively narrow shaft inner area 20c on the lower surface of the ceramic plate 20, the shaft inner area 20c does not need to have holes for a large number of temperature sensors, enabling effective use of the shaft inner area 20c.

Furthermore, the temperature detector passage 30 is curved. This enables the multi TC 40 to be smoothly inserted into the temperature detector passage 30.

Furthermore, the zones Z1 to Z6 include the circular center zone Z1 having a diameter smaller than that of the ceramic plate 20, the ring-shaped middle zone Z2 located outside the center zone Z1 and the first to forth divided outer zones 23 to 26 that are divided zones of the ring-shaped area having an outer diameter equal to the diameter of the ceramic plate 20 and an inner diameter larger than the diameter of the center zone Z1 (here the inner diameter equal to the outer diameter of the middle zone Z2). The temperature detector passage 30 has a swirl shape extending from the inlet 32 through the center zone Z1, then through the middle zone Z2 and then sequentially through the first to forth divided outer zones Z3 to Z6. The temperature detector passage 30 has a swirl shape, not a meandering shape, and thus the temperature detector passage 30 can have a relatively short length.

Furthermore, the multi TC 40 includes the single flexible protective tube 47 housing the plurality of sheathed TCs 41 to 46 having different lengths, and the sheathed TCs 41 to 46 have the temperature detecting portions 41m to 46m at their front ends. The wiring lines connected to the sheathed TCs 41 to 46 are bundled into the flat cable 49 at a bottom end of the multi TC 40. This configuration enables easy connection of the temperature detecting portions 41m to 46m of the multi TC 40 to an external device (controller 80) via the flat cable 49.

The present invention should not be limited to the above-described embodiment and may be implemented in various modes without departing from the technical scope of the present invention.

For example, in the above-described embodiment, the wafer placement surface 20a has six zones including the center zone Z1, the middle zone Z2, and the first to fourth divided outer zones Z3 to Z6, but the configuration of the zones should not be limited to this, and the number of zones may be any number greater than or equal to two. For example, the wafer placement surface 20a may be divided into two or more zones (a circular zone and one or more ring-shaped zones) by different-diameter circles concentric with the ceramic plate 20. Alternatively, the wafer placement surface 20a of the ceramic plate 20 may be divided into two or more zones by radial lines.

In the above-described embodiment, the plurality of zone heaters (the center zone heater 21, the middle zone heater 22, and the first to fourth divided outer zone heaters 23 to 26) embedded in the ceramic plate 20 are on the corresponding heater formation planes located at different heights from the wafer placement surface 20a, but this should not be construed as limiting. For example, the zone heaters may be on the heater formation planes at the same height from the wafer placement surface 20a, or some of the zone heaters may be on the heater formation planes at the same height and the others may be on the heater formation planes at different heights.

In the above-described embodiment, the jumpers 22c and 22d connecting the middle zone heater 22 to the terminals 22a and 22b are on the middle zone heater formation plane, but this should not be construed as limiting. For example, the heater formation plane and the jumper formation plane may be different planes. This is also applicable to the jumpers 23c, 23d, 24c, 24d, 25c, 25d, 26c, and 26d.

In the above-described embodiment, the multi TC 40 has the longest sheathed TC 46 along the central axis of the protective tube 47 and the other sheathed TCs 41 to 45 around the sheathed TC 46, but this should not be construed as limiting. For example, the sheathed TCs 41 to 46 may be randomly positioned in the protective tube 47.

In the above-described embodiment, the ceramic plate 20 may have a built-in electrostatic electrode. This configuration enables the wafer placed on the wafer placement surface 20a to be electrostatically adsorbed to the wafer placement surface 20a by application of a voltage to the electrostatic electrode. Alternatively, the ceramic plate 20 may have a built-in RF electrode. In such a case, a shower head (not illustrated) is disposed above the wafer placement surface 20a with a space therebetween, and RF power is applied between the parallel plate electrodes consisting of the shower head and the RF electrode. In this way, plasma is generated, and the wafer is subjected to CVD deposition or etching using the plasma. The electrostatic electrode may also be used as the RF electrode.

International Application No. PCT/JP2023/025885, filed on Jul. 13, 2023, is incorporated herein by reference in its entirety.

What is claimed is:

1. A ceramic heater comprising:
a ceramic plate having a wafer placement surface on its upper surface;
a plurality of zones in the wafer placement surface;
a zone heater embedded in the ceramic plate for each of the plurality of zones;
a single temperature detector passage in the ceramic plate; and
a single temperature detector located in the temperature detector passage, wherein
the temperature detector passage extends from an inlet in a lower surface of the ceramic plate through each of the plurality of zones, and
the temperature detector has a plurality of temperature detecting portions, and the plurality of temperature detecting portions are positioned at measurement positions corresponding to the plurality of zones.

2. The ceramic heater according to claim 1, further comprising:
a hollow shaft on the lower surface of the ceramic plate; and
a shaft inner area that is an area of the lower surface of the ceramic plate bounded by the hollow shaft, wherein
the inlet of the temperature detector passage is provided in the shaft inner area.

3. The ceramic heater according to claim 1, wherein the temperature detector passage is curved.

4. The ceramic heater according to claim 1, wherein the plurality of zones includes a circular center zone having a diameter smaller than that of the ceramic plate and a plurality of divided outer zones that are divided zones of a ring-shaped outermost outer zone having an outer diameter equal to the diameter of the ceramic plate and an inner diameter equal to or larger than the diameter of the center zone, and
the temperature detector passage has a swirl shape extending from the inlet through the measurement position corresponding to the center zone and then sequentially through the measurement positions for the plurality of divided outer zones.

5. The ceramic heater according to claim 1, wherein the temperature detector includes a single flexible protective tube housing a plurality of thermocouples having different lengths, the plurality of thermocouples have the temperature detecting portions at their front ends, and wiring lines connected to the plurality of thermocouples are bundled into a wiring assembly at a bottom end of the temperature detector.

6. The ceramic heater according to claim 1, wherein the temperature detector passage has a width of 1.5 mm to 3.0 mm and a height of 1.5 mm to 3.0 mm.
